(19) United States
(12) Patent Application Publication
(10) Pub. No.: US 2026/0310281 A1
(43) Pub. Date: Oct. 8, 2026

(54) Enhanced Sustainability By Managing Unused Features And Devices In A Data Center

(71) Applicant: American Megatrends International, LLC, Duluth, GA (US)

(72) Inventors: Varadachari Sudan Ayanam, Suwanee, GA (US); Chitrak Gupta, Johns Creek, GA (US)

(21) Appl. No.: 19/173,025

(22) Filed: Apr. 8, 2025

(51) Int. Cl. G06F 1/3296; G06F 1/3206

(52) U.S. Cl. CPC G06F 1/3296; G06F 1/3206

(57) ABSTRACT

In an aspect of the disclosure, a method, a computer-readable medium, and a computer system are provided. The computer system includes one or more computing devices. The one or more computing devices collect utilization data from a plurality of devices in a data center. The utilization data includes power consumption metrics and device usage statistics. The one or more computing devices analyze the collected utilization data to identify underutilized devices. The one or more computing devices generate power optimization actions for the identified underutilized devices. The one or more computing devices implement the power optimization actions to reduce power consumption of the underutilized devices.

### BACKGROUND

### Field

The present disclosure relates generally to computer systems, and more particularly, to techniques of managing power consumption of unused or underutilized features and devices in a data center environment to enhance sustainability.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v.2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

In modern data centers, power consumption and sustainability have become increasingly critical concerns as the scale of computing infrastructure continues to grow. Data center management has primarily focused on monitoring and optimizing the power usage of major components like CPUs and GPUs, which are typically the most power-hungry devices in server systems. However, the cumulative power consumption of secondary components and peripheral devices, while individually small, can add up to significant energy usage across thousands of servers in a data center.

Certain systems implement basic power management features through standard protocols like ACPI (Advanced Configuration and Power Interface) and vendor-specific power management utilities. These conventional approaches generally operate at a coarse level, managing power states of major components while leaving many peripheral devices and secondary systems continuously powered on. Baseboard Management Controllers (BMCs) have primarily served as monitoring and management interfaces, collecting sensor data and providing remote access capabilities, but historically have not been extensively utilized for granular power optimization of peripheral devices and unused features.

Data center power management solutions lacked sophisticated mechanisms for identifying and managing underutilized components at a granular level. While some systems could place entire servers into low-power states during periods of low utilization, they typically did not address the ongoing power consumption of individual subsystems like unused USB controllers, idle storage devices, or unnecessary video controllers in headless configurations. Additionally, some approaches lacked integration between real-time device utilization monitoring and automated power optimization actions, particularly for secondary systems and peripheral devices that contribute to overall power consumption.

The power management capabilities of BMCs may be limited to basic monitoring and control functions, without the ability to perform intelligent analysis of component utilization patterns or implement automated power optimization strategies. Systems may also lack comprehensive frameworks for collecting and analyzing detailed power usage metrics across multiple subsystems, making it difficult to identify opportunities for power savings in seemingly minor components that could provide significant cumulative benefits when optimized across large-scale deployments.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a computer system are provided. The computer system includes one or more computing devices. The one or more computing devices collect utilization data from a plurality of devices in a data center. The utilization data includes power consumption metrics and device usage statistics. The one or more computing devices analyze the collected utilization data to identify underutilized devices. The one or more computing devices generate power optimization actions for the identified underutilized devices. The one or more computing devices implement the power optimization actions to reduce power consumption of the underutilized devices.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller (BMC) and a host computer.

FIG. 2 is a diagram illustrating a system architecture for power optimization in a data center environment.

FIG. 3 is a diagram illustrating a hierarchical data collection and management architecture for sustainability optimization in a data center environment.

FIG. 4 is a table illustrating USB device power consumption showing various USB devices connected to a host computer or BMC along with their power usage characteristics.

FIG. 5 is a diagram illustrating a data analysis architecture for power optimization in a data center environment.

FIG. 6 is a flow chart of a method for managing power consumption in a data center.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

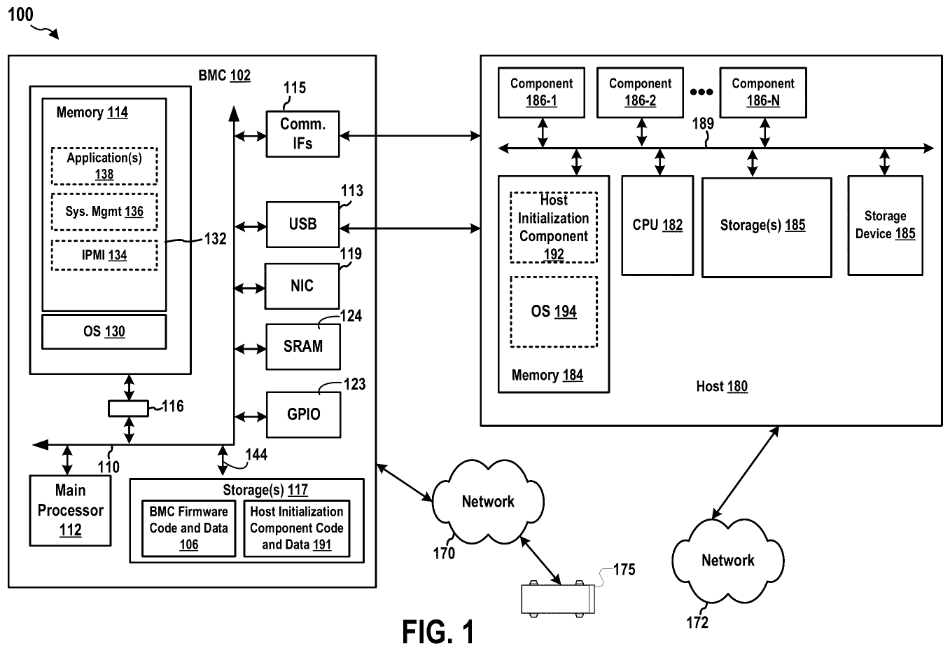

FIG. 1 is a diagram illustrating a computer system 100. In this example, the computer system includes, among other devices, a baseboard management controller (BMC) 102 and a host computer 180. The BMC 102 has, among other components, a main processor 112, a memory 114(e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123(i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170. Further, the storage(s) 117 is in communication with the communication channel 110 through a communication link 144.

In many data center deployments, multiple components on a server system consume power even when they remain underutilized. These components include the CPU 182, the GPU as part of the component devices 186-1 to 186-N, hard drives within the storage device(s) 185, and various interfaces like the USB interface 113 or the network interface card 119 in the BMC 102. Although overall power consumption is traditionally measured at the server level, there is a growing interest in optimizing the power consumption of secondary or rarely used subsystems. This optimization is of particular importance in light of modern sustainability measures, where a small reduction in power usage per server may result in significant energy savings across thousands of machines.

The BMC 102 is capable of monitoring hardware metrics, such as CPU utilization of the host CPU 182, I/O statistics of various component devices 186-1 to 186-N, and overall system temperature. In one implementation, data collection is performed through the communication interfaces 115, the USB interface 113, or proprietary sideband protocols. These methods collect utilization information for a range of subsystems, including storage devices in the storage device(s) 185, network controllers, and optional GPUs. The main processor 112 of the BMC 102 stores and processes this operational data in the memory 114, using the service components 132 to identify device-specific power usage characteristics.

The BMC 102 can operate in tandem with a remote management system on a cloud platform in order to analyze metrics over time. The remote management system receives time-series utilization statistics and power consumption data from the BMC 102 through the communication network 170. Following this collection, analysis can be performed to determine if any of the component devices 186-1 to 186-N or host resources have been underutilized. As an example, if the analysis shows that certain hard drives in the storage device(s) 185 remain idle for extended periods, the BMC 102 can configure those storage devices to enter a low-power state. A similar approach can be taken for a GPU among the component devices 186-1 to 186-N if usage levels remain consistently low.

In certain configurations, the system described in FIG. 1 may include functionality for selectively enabling and disabling components to reduce power consumption in a data center environment. A primary factor involves identifying when particular devices or features of the baseboard management controller (the BMC 102) and the host computer 180 remain underutilized. The BMC 102 collects utilization statistics from the component devices 186-1 to 186-N, including a GPU or other peripheral devices, and from storage device(s) 185. These statistics can be gathered through out-of-band interfaces, such as the communication interfaces 115 or a sideband protocol. The service components 132, executed by the main processor 112 of the BMC 102, can record key parameters indicating activity levels, temperature, power usage, and other relevant metrics. For instance, if the USB interface 113 remains idle for extended periods, or if a display controller is unnecessary in a headless configuration, the BMC 102 can either switch these features off or set them to a low-power state.

This data collection process, which can be centralized in the BMC 102, may be further coordinated with an external platform, such as a cloud platform, that processes time-series information regarding device utilization. The BMC 102 relays measurements of total system power draw and subsystem utilization to the cloud platform through the communication network 170, allowing a more advanced computational model to analyze historical patterns of device usage. This model, which may be implemented by an AI model, can interpret whether the GPU among the component devices 186-1 to 186-N or certain hard drives in storage device(s) 185 remain unused for sufficient durations to justify placing them in a low-power state. The results of these analyses are then conveyed back to the BMC 102, either automatically or upon request by an administrator, so that the BMC firmware code and data 106 can execute corrective actions via application(s) 138.

In some implementations, the BMC 102 can perform a simplified version of the analysis locally, using heuristic rules that determine whether a given component is frequently accessed. The system management component 136 may parse data indicating reads and writes for a subset of storage device(s) 185, or network transmit and receive counts for a network interface card, and combine that information with power usage estimates derived from the power supply sensors. When underutilization is detected, the BMC 102 sends commands to shut down or reduce the clock rates of targeted peripherals. In cases where reactivation is required, an interrupt in the BMC 102 or a request from the host OS 194 may trigger the re-enablement of the device.

In one scenario, if multiple hard drives remain idle in the storage device(s) 185, the BMC 102 can place them in a spin-down or standby mode. A similar approach may be used to disable a GPU if the utilization remains below a specified threshold over a defined period. Through either an in-band command sequence or an out-of-band mechanism that bypasses the OS 194, the service components 132 issue directives to lower power states in accordance with policies maintained by the system management component 136. The aggregation of such incremental power reductions achieves significant improvements in data center power profiles, especially when scaled to large deployments. This approach aligns with sustainability targets, because even small reductions per server translate into substantial total power savings across thousands of servers. The ability of the BMC 102 to dynamically monitor and manage multiple devices, as well as report these actions to the cloud platform for further analysis, provides an adaptable solution to optimize resource usage in real time without disrupting core system operations.

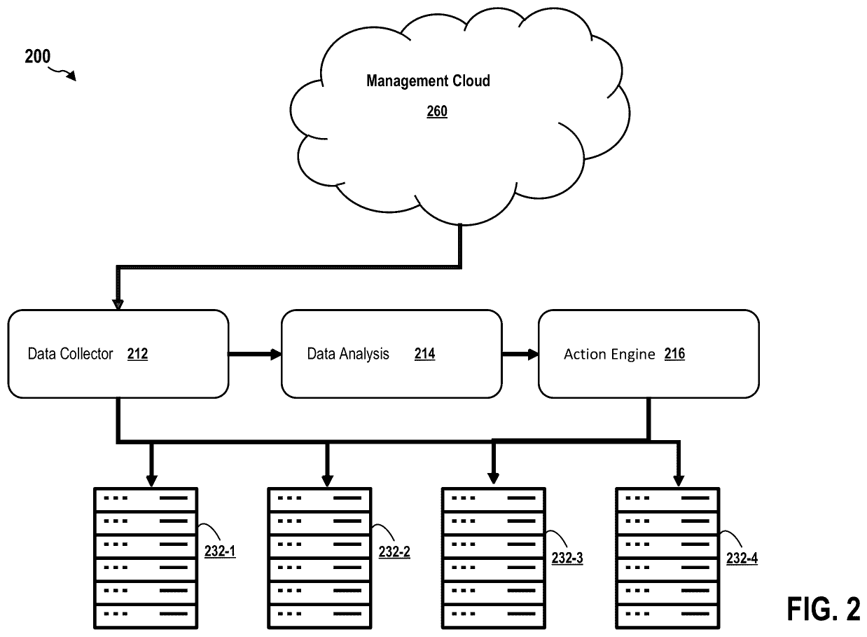

FIG. 2 is a diagram 200 illustrating a system architecture for power optimization in a data center environment. The system includes a management cloud 260, which hosts a cloud platform for centralized management of power consumption across multiple server racks 232-1, 232-2, 232-3, and 232-4. The management cloud 260 interfaces with three primary components: a data collector 212, a data analysis component 214, and an action engine 216, which work together to implement power optimization strategies.

The data collector 212 operates as the primary gathering point for system metrics from the server racks 232-1 through 232-4, etc. It continuously monitors various parameters including power consumption, device utilization, and operational statistics. This component interfaces with BMCs in each server to collect detailed metrics through standard protocols such as PLDM (Platform Level Data Model) and NC-SI (Network Controller Sideband Interface), as well as vendor-specific interfaces for components like GPUs and storage controllers.

The data analysis component 214 processes the collected information to identify patterns of device utilization and power consumption. It implements both simple heuristic models for immediate power optimization decisions and complex analytical models that can run in the management cloud 260. The analysis component 214 generates detailed reports in standardized formats such as JSON or XML, which contain recommendations for power optimization actions. These recommendations can include immediate automated actions for clearly underutilized devices and proposed changes that require administrator approval for more complex scenarios.

The action engine 216 serves as the execution component that implements the power optimization decisions. It receives directives from the data analysis component 214 and translates them into specific commands for the BMCs and device controllers in the server racks 232-1 through 232-4. The action engine 216 can execute both out-of-band commands directly to hardware components and in-band commands that require operating system involvement. This component supports various power management actions, from simple device power-state transitions to more complex operations such as workload consolidation across storage devices or compute resources.

The server racks 232-1 through 232-4 represent the managed infrastructure where power optimization is implemented. Each rack contains multiple servers with their own BMCs, storage devices, network interfaces, and other components that can be individually monitored and controlled for power optimization. The system architecture allows for scalable power management across these racks, with the management cloud 260 coordinating the optimization efforts across the entire data center infrastructure.

This architecture supports both simple power optimization scenarios, such as disabling unused USB controllers or network interfaces, and complex scenarios involving workload redistribution and resource consolidation. The management cloud 260 maintains historical data and utilization patterns, enabling sophisticated analysis for long-term power optimization strategies while allowing immediate action for clear cases of resource underutilization.

In one illustrative implementation, the data collector 212 in the management cloud 260 receives continuous utilization data from the BMC 102 located in each server within the racks of servers 232-1, 232-2, 232-3, and 232-4. The data collector 212 gathers information on device usage and overall system power draw over a selected interval, e.g., one week, and stores the measurements in a time-series database. The BMC 102, using sideband or in-band interfaces, retrieves resource utilization metrics for the CPU 182, any GPU in the component devices 186-1 to 186-N, the storage device(s) 185, and peripheral subsystems such as the USB interface 113. The data collector 212 relays these metrics to the data analysis component 214, which applies both heuristic algorithms and an AI model to identify devices that remain in low-utilization states.

During analysis, the data analysis component 214 correlates resource utilization with associated power consumption estimates, determining if specified subsystems can be consolidated or placed in a reduced-power state. For example, when multiple hard drives in the storage device(s) 185 are seldom accessed, the data analysis component 214 can recommend spinning down selected drives or migrating data to a smaller set of disks, allowing the remaining drives to transition into a low-power mode. Similarly, a GPU among the component devices 186-1 to 186-N that shows sporadic usage may be put into a reduced-power state or fully disabled until a workload request arrives. The data analysis component 214 then creates a structured report that ranks possible power-saving actions according to factors such as estimated energy reduction, host activity patterns, and cost implications.

The action engine 216 receives the report and classifies proposed changes into automated actions and actions requiring administrative approval. Non-disruptive tasks, such as placing an idle peripheral in standby mode, may occur immediately. Potentially disruptive actions, including storage consolidation or disabling of a major subsystem, may be queued for review by an administrator. Upon approval, the action engine 216 issues device-specific commands to the BMC 102 through an out-of-band interface connected to the communication network 170. For example, the action engine 216 may instruct the RAID controller to move data across drives in the storage device(s) 185 or configure a GPU in the component devices 186-1 to 186-N to enter a lower clock configuration. This process can be repeated continuously or periodically, with the data collector 212 updating the management cloud 260 on the power usage impact of each action.

In particular, the action engine 216 may execute the power optimization decisions through direct communication with the BMC 102. These actions can include transitioning devices to low-power states or complete shutdown of unused components. The action engine 216 can issue commands to various controllers, including storage controllers and GPU interfaces, implementing power state changes through both out-of-band and in-band mechanisms. The BMC 102 facilitates these actions through standardized protocols such as PLDM for general device management and specialized interfaces for specific components such as GPU power management.

As described supra, the BMC 102 implements multiple protocols and interfaces for comprehensive monitoring of system components. Through the communication interfaces 115, the BMC 102 utilizes PLDM commands as the primary standard interface for collecting statistics information from various devices. For network monitoring, the BMC 102 employs Network Controller Sideband Interface (NC-SI) protocols to gather network traffic statistics without accessing the actual data packets.

The monitoring capabilities extend to vendor-specific protocols for specialized hardware. For instance, GPU monitoring in the component devices 186-1 to 186-N utilizes System Management Bus (SMBus) protocols to collect GPU utilization metrics, power consumption data, and temperature readings. Storage controllers in the storage device(s) 185 may implement proprietary APIs for detailed drive statistics collection.

The data collector 212 in the management cloud 260 aggregates these various data streams, creating a comprehensive view of system utilization. The BMC 102 maintains continuous monitoring of read and write operations for the storage device(s) 185, tracking metrics such as I/O rates and access patterns. Similarly, for network interfaces, the BMC 102 collects transmission and reception statistics through sideband channels, enabling power optimization decisions without impacting the data path.

The data analysis component 214 processes this collected information using both local analysis within the BMC 102 and cloud-based processing in the management cloud 260. The action engine 216 then implements power state changes through appropriate protocols, whether through standard PLDM commands or vendor-specific interfaces.

This monitoring architecture supports granular power management across the server racks 232-1, 232-2, 232-3, and 232-4, with each BMC 102 providing detailed utilization data that contributes to system-wide optimization decisions. Over time, the BMC 102 refines its monitoring thresholds, enabling the system management component 136 to balance performance needs against power reductions. Historical analyses from the data analysis component 214 help the firmware provider to adjust firmware strategies within the BMC 102, tailoring power management policies to reflect specific environmental conditions. Underutilized resources are identified and deactivated or scaled down, and the resulting power usage data is incorporated into subsequent analyses for more efficient operation. This continuous cycle of monitoring, analysis, and action facilitates overall power savings in large-scale data center deployments.

In certain configurations, the BMC 102 is capable of performing a cost analysis and a power analysis locally by examining device usage over a defined timeframe. Alternatively, such detailed calculations may be handed over to the management cloud 260, which can host large-scale computational models. The BMC 102 gathers raw data such as device inventories, power metrics, and utilization statistics, then transfers this information to the data collector 212. Over a period of time, the data collector 212 compiles these measurements for various hardware components, including storage device(s) 185 and GPU units among the component devices 186-1 to 186-N, in the racks of servers 232-1, 232-2, 232-3, and 232-4. Once collected, the information is processed by the data analysis component 214 to generate determinations regarding which devices or features exhibit inadequate usage relative to their power consumption.

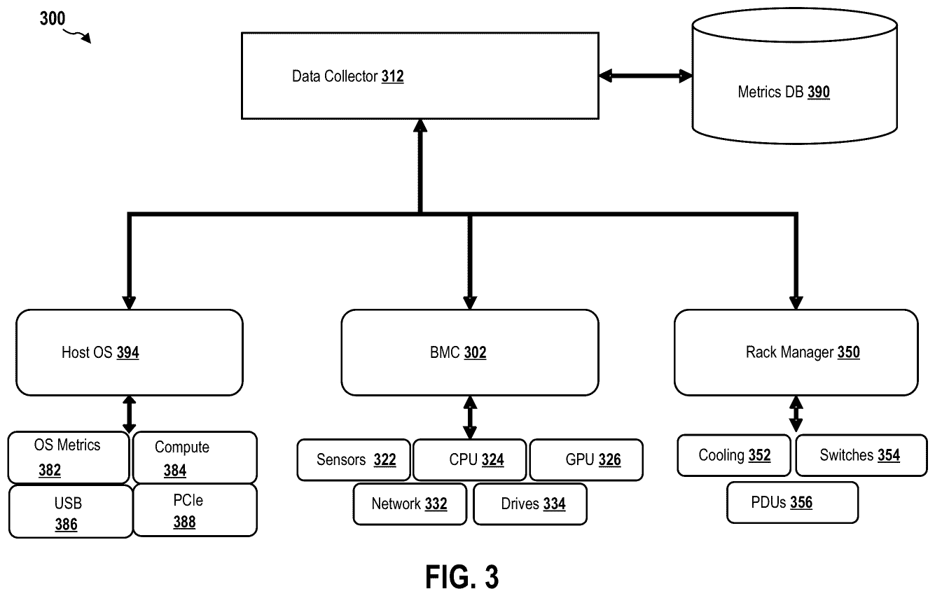

FIG. 3 is a diagram 300 illustrating a hierarchical data collection and management architecture for sustainability optimization in a data center environment. The architecture includes three primary layers of components that interact to monitor and control power consumption: a data collection layer centered around a data collector 312 and a metrics database 390, a host system layer including a host OS 394 and its managed components, and a hardware management layer comprising a BMC 302 and a rack manager 350.

The data collector 312 serves as the central aggregation point for system metrics, maintaining bidirectional communication with the metrics database 390 for persistent storage of collected information. The data collector 312 interfaces with three primary sources of metric data: the host OS 394, the BMC 302, and the rack manager 350. This hierarchical collection structure enables comprehensive monitoring of power consumption and utilization metrics across multiple levels of the data center infrastructure.

At the host system level, the host OS 394 manages several key components that contribute to the system's power profile. The OS metrics component 382 monitors operating system-level statistics, while the compute components 384 encompass CPU and GPU resources. The host OS 394 also oversees the USB devices 386 and PCIe devices 388, tracking their utilization and power states. This granular monitoring at the operating system level provides detailed insights into component-level power consumption patterns.

The BMC 302 maintains direct communication with various hardware components, including the sensors 322 for environmental metrics, the CPU 324 and GPU 326 for processor-level monitoring, and network interfaces 332 and drives 334 for I/O subsystem oversight. Through standardized protocols such as PLDM and vendor-specific interfaces, the BMC 302 collects real-time data about component utilization and power consumption. This data feeds into the broader sustainability management framework through the data collector 312.

The rack manager 350 oversees rack-level infrastructure components, maintaining communication with cooling components 352, switches 354, and power distribution units (PDUs) 356. This management layer provides essential information about power distribution and thermal conditions at the rack level, allowing for optimization of cooling resources and network power consumption. The coordination between the rack manager 350 and the data collector 312 enables system-wide power optimization strategies that consider both individual server components and shared infrastructure resources.

The metrics database 390 stores time-series information about power consumption, temperature, cooling metrics, and utilization statistics collected from all layers of the architecture. This centralized repository allows administrators to analyze historical trends and implement cost-effective power management strategies. The database supports the inclusion of additional metrics such as power and water cost information, enabling comprehensive analysis of sustainability impacts.

Through this hierarchical architecture, the system can implement both automated power optimization actions and administrator-guided sustainability initiatives. The data collector 312 aggregates information from all layers, enabling sophisticated analysis of power consumption patterns and identification of optimization opportunities across the entire data center infrastructure. This comprehensive approach to data collection and management supports the goal of enhanced sustainability through precise control of unused or underutilized features and devices in the data center environment.

In many data center scenarios, effective sustainability management is contingent upon acquiring and maintaining comprehensive metric data from both hardware and software layers. As depicted in FIG. 2 and FIG. 3, the solution employs a data collection entity that acquires multiple metric points from the systems in the data center, including those originating from a baseboard management controller (the BMC 302), various agents running on a host operating system (the host OS 394), and a rack manager (the rack manager 350). The BMC 302 gathers operational data from sensors 322, a CPU 324, a GPU 326, network interfaces 332, and drives 334, while the host OS 394 monitors compute components 384 such as CPUs and GPUs, as well as USB devices 386 and PCIe devices 388. The rack manager 350 supervises rack-level elements such as the cooling components 352, the switches 354, and the PDUs 356.

In the example of FIG. 3, the data collector 312 communicates with the metrics DB 390 to store time-series information that encompasses system power consumption, temperature, cooling parameters, and utilization values. Standard metric collection utilities in the host OS 394, such as vendor-specific tools and open-source scrapers compatible with programs like nvidia-smi, provide detailed usage data for components such as GPUs and other peripherals. The BMC 302 likewise transmits out-of-band or sideband metrics to the data collector 312 by using recognized protocols (for example, PLDM or NC-SI) or vendor-defined interfaces. Collected data may include instantaneous and historical measures that allow the solution to detect underutilized hardware or auxiliary features contributing to power overhead. The metrics DB 390 thus maintains these observations, permitting longer-term trending and analysis.

Administrators can incorporate additional variables into the stored data, such as the cost of power, water, or other relevant resources for more extensive analysis. By correlating component-level utilization with these resource costs, the system can identify opportunities to deactivate infrequently used devices or reduce power usage in specific subsystems. For instance, if a GPU 326 remains consistently idle, the BMC 302 may receive directives to reduce the clock rate or switch the device to a low-power state. In the same manner, a subset of drives 334 in the storage system could be spun down based on minimal access patterns. This comprehensive, time-series approach creates a foundation for both straightforward heuristic methods and more advanced analyses that can be executed by the data analysis component 214 within a cloud platform or directly by the BMC 302.

The data collection architecture thus covers hardware and software monitoring, with the BMC 302 focusing on device-level metrics and the host OS 394 capturing operating system statistics and application usage. The data collector 312 integrates these multiple data streams, deposits the metrics in the metrics DB 390, and serves as a conduit for subsequent processing in the management cloud 260. In this manner, system administrators and automated decision-making modules benefit from a complete view of power, temperature, utilization, and operating costs. Such broad visibility supports the actions carried out by the action engine 216, which may coordinate simple power adjustments (such as disabling idle USB devices 386) or more complex tasks (such as consolidating data on a smaller set of drives 334). Once the relevant metrics are collected and stored, the data analysis component 214 can pinpoint potential power savings and propose ways to reduce resource consumption, thereby facilitating continuous improvements in data center sustainability.

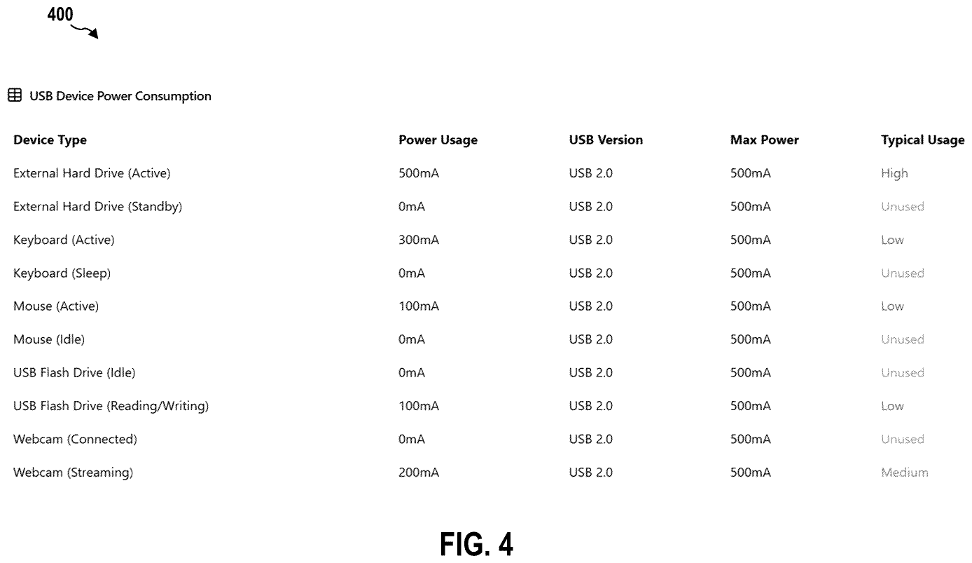

FIG. 4 is a table 400 illustrating an example of USB device power consumption. The table 400 shows various USB devices connected to a host computer 180 or a BMC 102, along with their power usage characteristics. This data is representative of the type of information that a data collector 212, 312 can gather to facilitate power management decisions. The table 400 includes columns for “Device Type”, “Power Usage”, “USB Version”, “Max Power”, and “Typical Usage”. The “Device Type” column lists different USB peripherals such as external hard drives, keyboards, mice, USB flash drives, and webcams. The “Power Usage” column indicates the current power draw of each device in milliamperes (mA). The “USB Version” column specifies the USB standard supported by the device, such as USB 2.0 or USB 3.0. The “Max Power” column indicates the maximum power that the device is rated to draw. The “Typical Usage” column provides a qualitative assessment of how frequently the device is used, categorized as “High”, “Medium”, “Low”, or “Unused”.

The data in the table 400 highlights the potential for power savings by identifying devices that are either in an idle or standby state or are infrequently used. For example, devices in particular states such as the “External Hard Drive (Standby)”, “Keyboard (Sleep)”, “Mouse (Idle)”, “USB Flash Drive (Idle)”, and “Webcam (Connected)” all show a power usage of 0 mA, indicating that they are not actively consuming power. These devices are prime candidates for being switched off or placed in a low-power state by an action engine 216 to reduce overall system power consumption. A data analysis component 214 can use this information, along with historical usage data collected over time, to make informed decisions about which devices can be safely powered down without impacting system functionality.

The table 400 also illustrates the varying power consumption of devices based on their activity level. For instance, the “External Hard Drive” consumes 500 mA when active but 0 mA in standby mode. Similarly, the “Webcam” uses 0 mA when simply connected but draws 200 mA while streaming. This information can be used by the data analysis component 214 to develop more granular power management strategies. For example, the system might implement policies to automatically place devices into their low-power states when they are not actively being used for a certain period.

This USB device power consumption data is just one example of the many types of metrics that the system collects and analyzes. A BMC 102, 302 can gather similar information for other components, such as a CPU 182, GPUs in the component devices 186-1 to 186-N, storage device(s) 185, network interfaces 332, and even internal components within the BMC 102 itself. By combining this detailed power consumption data with utilization statistics and cost information, the system can make intelligent decisions about how to optimize power usage across an entire data center, resulting in significant energy savings and improved sustainability. The action engine 216, guided by the analysis of the data analysis component 214, can then send appropriate commands to the various devices and controllers to implement these power-saving measures.

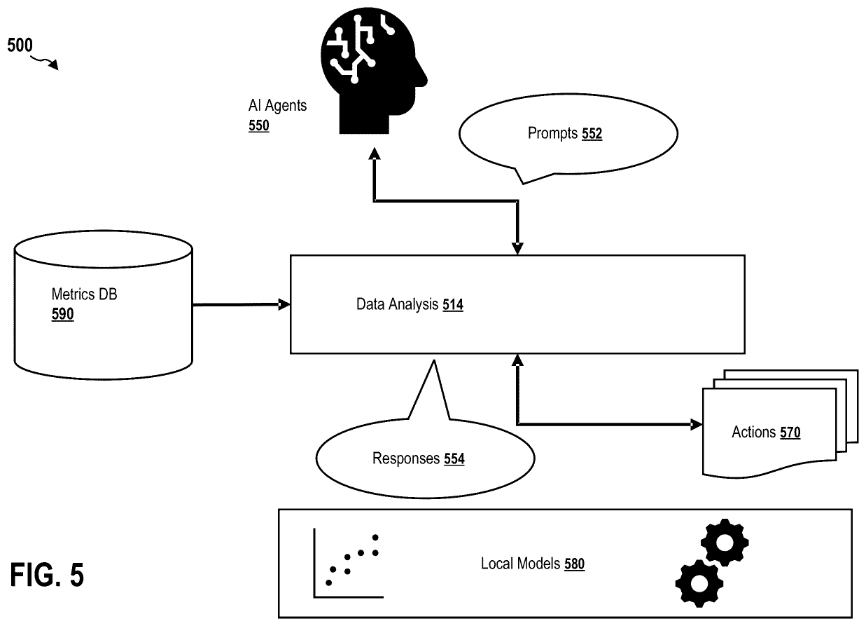

FIG. 5 is a diagram 500 illustrating a data analysis architecture for power optimization in a data center environment. This diagram depicts the interaction between a data analysis component 514, AI agents 550, prompts 552, responses 554, local models 580, actions 570, and a metrics DB 590. The data analysis component 514 forms the central processing unit of the architecture, receiving inputs from multiple sources and generating outputs to drive power optimization actions.

The data analysis process begins with information stored in the metrics DB 590, which feeds into the data analysis component 514. This component employs a dual-analysis approach, utilizing both AI agents 550 and local models 580. The AI agents 550 receive structured prompts 552 that guide their analysis of the collected metrics data. These prompts 552 are specifically designed to extract meaningful patterns from power consumption and device utilization data. For instance, a prompt might request identification of storage devices that could be deactivated to achieve a specified power reduction target.

The AI agents 550 generate responses 554 based on their analysis of the presented data and prompts. These responses 554 feed back into the data analysis component 514, where they are further refined using local models 580. The local models 580 incorporate site-specific parameters and historical performance data to fine-tune the generic recommendations provided by the AI agents 550. The combination of AI-driven analysis and local model optimization enables the system to generate highly contextual power optimization recommendations.

The data analysis component 514 processes both the AI-generated responses 554 and local model computations to formulate specific actions 570. These actions 570 represent concrete power optimization steps that can be implemented in the data center environment. For example, if the analysis identifies consistently idle hard drives, the actions 570 might include commands to transition these drives into low-power states or consolidate data onto fewer active drives.

The architecture may also implement a feedback loop where the results of implemented actions 570 are recorded back into the metrics DB 590, allowing the system to continuously refine its optimization strategies. This iterative process enables the system to adapt to changing workload patterns and environmental conditions while maintaining optimal power efficiency across the data center infrastructure.

In particular, the data analysis process begins with formulating specific, structured prompts 552 for the AI agents 550. These prompts 552 are designed to query the collected data in a way that reveals potential power-saving opportunities. For example, a prompt might be phrased as: “Tell me which hard drives can be switched off based on the information in the table that reduces 5% of power.” This prompt directs the AI agent 550 to analyze the available data, which may include metrics such as hard drive utilization, power consumption, and I/O activity, all collected and stored in the metrics DB 590 by the data collector 212, 312. The AI agent 550 processes this prompt and provides the responses 554.

The AI agent's response 554, which identifies potentially underutilized hard drives, is not implemented directly. Instead, it serves as input for further refinement using local models 580. The local models 580 incorporate knowledge of the specific data center environment and historical data. This includes information on hard drive groupings (e.g., RAID configurations), data redundancy requirements, and application-specific access patterns. By combining the AI's general recommendations with this local context, the system avoids overly aggressive power-saving measures that might compromise data availability or system performance.

A similar methodology applies to other devices, such as USB peripherals. The data analysis component 514 can formulate prompts to identify unused or infrequently used USB devices. The table 400 in FIG. 4 illustrates an example of USB device power consumption data that can be collected and analyzed. As shown in the table 400, various USB devices are listed with their corresponding power usage in different states.

The data analysis component 514, in conjunction with the AI agents 550, processes this information to identify potential candidates for power optimization. A prompt 552, such as “Show me the devices that can be turned off in the USB usage table,” is issued to the AI agent 550. The AI agent 550 analyzes the data presented in the table 400, considering factors like the “Power Usage” and “Typical Usage” columns. The AI agent 550 generates a response 554 based on the analysis of the presented prompt 552 and table 400.

Based on this analysis, the response 554 can identify specific devices that are either marked as “Unused” or have a power usage of 0 mA, indicating minimal or no activity. The devices, such as an external hard drive in standby mode, a keyboard in sleep mode, a mouse in idle mode, a USB flash drive in idle mode, and a webcam that is simply connected, are identified as suitable for power-saving measures. These identified devices are not actively consuming resources and can be turned off or disconnected if not needed.

The data analysis component 514 then uses the local models 580. The local models 580 may use further information, which includes device dependencies and historical usage, to decide which devices to shut down and which devices to keep on. The final recommendation of the devices to shut down or to keep on goes to the action engine 216. The action engine 216 takes actions to implement the power-saving measures, which is either automatically shut down or proposed to the administrator to be shut down, that are proposed by the data analysis component 514.

Further, as described supra, the action engine 216 processes outputs generated by the data analysis component 214 and implements power optimization actions 570 through a structured decision-making framework. The actions 570 are categorized into two primary groups: automatic actions and manual actions. This classification system enables the action engine 216 to appropriately handle different types of power optimization measures based on their potential impact on system operations.

The automatic actions encompass operations that can be executed without administrative intervention. These typically include non-destructive measures such as transitioning unused devices into low-power states. For instance, when the data analysis component 214 identifies USB devices 386 that have remained idle for an extended period, the action engine 216 can automatically initiate power state transitions. Similarly, when the GPU 326 exhibits minimal utilization, the action engine 216 can implement automatic clock-rate reductions or power-state changes without requiring explicit administrator approval.

Manual actions, conversely, require explicit administrator authorization before implementation. These actions typically involve operations that could potentially impact system availability or data integrity. For example, shutting down drives 334 or modifying I/O device configurations requires careful consideration of ongoing system operations and data accessibility requirements. The action engine 216 presents these proposed actions to system administrators through a structured interface, allowing them to evaluate the potential impact and approve or modify the suggested changes.

Administrators can establish customized rules within the action engine 216 to govern both automatic and manual actions. These rules can incorporate various parameters, including power consumption thresholds, device utilization metrics, and cost factors. The cost considerations may encompass both direct power expenses and indirect costs associated with cooling and infrastructure support. The action engine 216 evaluates these rules against the current system state and historical patterns stored in the metrics DB 590 to determine appropriate power optimization measures.

The action engine 216 maintains detailed records of implemented actions and their impacts, generating comprehensive sustainability reports. These reports quantify potential and achieved power savings, providing administrators with concrete metrics to evaluate the effectiveness of various optimization strategies. The reports may include analyses of power consumption trends, cost savings calculations, and projections of long-term sustainability improvements based on implemented actions.

Through this structured approach to action implementation, the system maintains a balance between aggressive power optimization and operational stability. The action engine 216 coordinates with the BMC 302 and the rack manager 350 to implement approved changes, while continuously monitoring the impact of these actions through the data collector 312 and the metrics DB 390. This feedback loop enables ongoing refinement of power optimization strategies while maintaining system reliability and performance requirements.

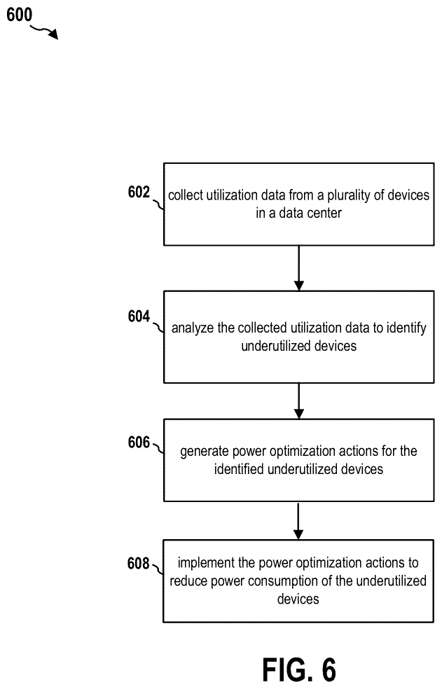

FIG. 6 is a flow chart 600 of a method for managing power consumption in a data center. The method may be performed by one or more computing devices (e.g., the BMC 102, computing devices implementing the management cloud 260, ) . In operation 602, the one or more computing devices collect utilization data from a plurality of devices in a data center, the utilization data including power consumption metrics and device usage statistics. In operation 604, the one or more computing devices analyze the collected utilization data to identify underutilized devices. In operation 606, the one or more computing devices generate power optimization actions for the identified underutilized devices. In operation 608, the one or more computing devices implement the power optimization actions to reduce power consumption of the underutilized devices.

To collect the utilization data, the one or more computing devices receive, by a data collector, device metrics from at least one of a baseboard management controller (BMC), an operating system agent, and a rack manager, store the device metrics in a metrics database as time-series information, and incorporate cost information associated with power and cooling resources into the stored device metrics. The device metrics include at least one of: sensor data from hardware components, CPU and GPU utilization statistics, network interface traffic data, storage device access patterns, and cooling system parameters.

To analyze the collected utilization data, the one or more computing devices provide prompts to artificial intelligence (AI) agents regarding potential power optimization opportunities, receive responses from the AI agents identifying candidate devices for power reduction, process the responses using local models that incorporate site-Attorney specific parameters, and generate device-specific power optimization recommendations. In certain configurations, the local models incorporate at least one of: historical device usage patterns, device dependencies, data redundancy requirements, and application-specific access patterns.

To generate the power optimization actions, the one or more computing devices classify proposed actions into automatic actions and manual actions, implement the automatic actions without administrator intervention, and present the manual actions for administrator approval before implementation. In certain configurations, the automatic actions comprise transitioning unused devices into low-power states, and the manual actions comprise operations affecting system availability or data integrity.

The one or more computing devices monitor impacts of implemented power optimization actions, generate sustainability reports quantifying achieved power savings, and refine future power optimization strategies based on the monitored impacts. In certain configurations, implementing the power optimization actions comprises at least one of: disabling unused USB controllers, transitioning idle storage devices to low-power states, reducing clock rates of underutilized GPUs, and consolidating data onto fewer active storage devices.

The one or more computing devices establish power optimization rules incorporating power consumption thresholds and cost factors, evaluate the rules against current system states and historical patterns, and determine appropriate power optimization measures based on the evaluation. To collect the utilization data, the one or more computing devices gather metrics through standardized protocols including Platform Level Data Model (PLDM) and Network Controller Sideband Interface (NC-SI), and collect vendor-specific metrics through proprietary interfaces.

The one or more computing devices maintain a record of USB device power consumption characteristics, identify USB devices with minimal or no activity, and selectively disable power to the identified USB devices. To analyze the collected utilization data, the one or more computing devices correlate component-level utilization with resource costs, identify patterns of device usage over defined timeframes, and determine power reduction opportunities based on the correlated data and identified patterns.

The one or more computing devices monitor reactivation requests for devices affected by power optimization actions, restore power to devices based on the reactivation requests, and update device usage patterns based on the reactivation requests. To implement the power optimization actions, the one or more computing devices coordinate with the BMC to execute power state changes, verify successful implementation of the power optimization actions, and record the implemented actions in a sustainability report.

In certain configurations, the computing devices and components shown in FIGS. 2-5 may be implemented by the computer system 100 shown in FIG. 1. For example, the management cloud 260 may be implemented by the host computer 180, with the data collector 212, data analysis component 214, and action engine 216 being implemented as software components executed by the host CPU 182. Alternatively, these components may be implemented by the BMC 102, with the main processor 112 executing the data collector 212, data analysis component 214, and action engine 216 as part of the service components 132. The metrics database 390 may be implemented in the storage device(s) 185 of the host computer 180 or in the storage(s) 117 of the BMC 102.

The data collection and analysis architecture shown in FIG. 3 may similarly be implemented within the computer system 100, with the data collector 312 and metrics DB 390 being implemented by either the host computer 180 or BMC 102. The host OS 394 corresponds to the OS 194 running on the host computer 180, while the BMC 302 corresponds to the BMC 102. The data analysis architecture of FIG. 5, including the data analysis component 514, AI agents 550, and local models 580, may be implemented as software components executed by either the host CPU 182 or the main processor 112 of the BMC 102, with the metrics DB 590 being stored in either the storage device(s) 185 or storage(s) 117 respectively.

It is understood that the specific order or hierarchy of blocks in the processes / flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
collecting utilization data from a plurality of devices in a data center, the utilization data including power consumption metrics and device usage statistics;
analyzing the collected utilization data to identify underutilized devices;
generating power optimization actions for the identified underutilized devices; and
implementing the power optimization actions to reduce power consumption of the underutilized devices.

2. The method of claim 1, wherein collecting the utilization data comprises:
receiving, by a data collector, device metrics from at least one of a baseboard management controller (BMC), an operating system agent, and a rack manager;
storing the device metrics in a metrics database as time-series information; and
incorporating cost information associated with power and cooling resources into the stored device metrics.

3. The method of claim 2, wherein the device metrics include at least one of:
sensor data from hardware components;
CPU and GPU utilization statistics;
network interface traffic data;
storage device access patterns; and
cooling system parameters.

4. The method of claim 1, wherein analyzing the collected utilization data comprises:
providing prompts to artificial intelligence (AI) agents regarding potential power optimization opportunities;
receiving responses from the AI agents identifying candidate devices for power reduction;
processing the responses using local models that incorporate site-specific parameters; and
generating device-specific power optimization recommendations.

5. The method of claim 4, wherein the local models incorporate at least one of:
historical device usage patterns;
device dependencies;
data redundancy requirements; and
application-specific access patterns.

6. The method of claim 1, wherein generating the power optimization actions comprises:
classifying proposed actions into automatic actions and manual actions;
implementing the automatic actions without administrator intervention; and
presenting the manual actions for administrator approval before implementation.

7. The method of claim 6, wherein:
the automatic actions comprise transitioning unused devices into low-power states; and
the manual actions comprise operations affecting system availability or data integrity.

8. The method of claim 1, further comprising:
monitoring impacts of implemented power optimization actions;
generating sustainability reports quantifying achieved power savings; and
refining future power optimization strategies based on the monitored impacts.

9. The method of claim 1, wherein implementing the power optimization actions comprises at least one of:
disabling unused USB controllers;
transitioning idle storage devices to low-power states;
reducing clock rates of underutilized GPUs; and
consolidating data onto fewer active storage devices.

10. The method of claim 1, further comprising:
establishing power optimization rules incorporating power consumption thresholds and cost factors;
evaluating the rules against current system states and historical patterns; and
determining appropriate power optimization measures based on the evaluation.

11. The method of claim 1, wherein collecting the utilization data comprises:
gathering metrics through standardized protocols including Platform Level Data Model (PLDM) and Network Controller Sideband Interface (NC-SI); and
collecting vendor-specific metrics through proprietary interfaces.

12. The method of claim 1, further comprising:
maintaining a record of USB device power consumption characteristics;
identifying USB devices with minimal or no activity; and
selectively disabling power to the identified USB devices.

13. The method of claim 1, wherein analyzing the collected utilization data comprises:
correlating component-level utilization with resource costs;
identifying patterns of device usage over defined timeframes; and
determining power reduction opportunities based on the correlated data and identified patterns.

14. The method of claim 1, further comprising:
monitoring reactivation requests for devices affected by power optimization actions;
restoring power to devices based on the reactivation requests; and
updating device usage patterns based on the reactivation requests.

15. The method of claim 1, wherein implementing the power optimization actions comprises:
coordinating with at least one of a baseboard management controller (BMC) and a host computer to execute power state changes, wherein the power state changes are implemented by software components executed by the at least one of the BMC and the host computer;
verifying successful implementation of the power optimization actions; and
recording the implemented actions in a sustainability report.

16. A system, including one or more computing devices, comprising:
a memory; and
at least one processor coupled to the memory and configured to:
collect utilization data from a plurality of devices in a data center, the utilization data including power consumption metrics and device usage statistics;
analyze the collected utilization data to identify underutilized devices;
generate power optimization actions for the identified underutilized devices; and
implement the power optimization actions to reduce power consumption of the underutilized devices.

17. The system of claim 16, wherein to collect the utilization data, the at least one processor is further configured to:
receive, by a data collector, device metrics from at least one of a baseboard management controller (BMC), an operating system agent, and a rack manager;
store the device metrics in a metrics database as time-series information; and
incorporate cost information associated with power and cooling resources into the stored device metrics.

18. The system of claim 17, wherein the device metrics include at least one of:
sensor data from hardware components;
CPU and GPU utilization statistics;
network interface traffic data;
storage device access patterns; and
cooling system parameters.

19. The system of claim 16, wherein to analyze the collected utilization data, the at least one processor is further configured to:
provide prompts to artificial intelligence (AI) agents regarding potential power optimization opportunities;
receive responses from the AI agents identifying candidate devices for power reduction;
process the responses using local models that incorporate site-specific parameters; and
generate device-specific power optimization recommendations.

20. A non-transitory computer-readable medium storing computer executable code for operating one or more computing devices, comprising code to:
collect utilization data from a plurality of devices in a data center, the utilization data including power consumption metrics and device usage statistics;
analyze the collected utilization data to identify underutilized devices;
generate power optimization actions for the identified underutilized devices; and
implement the power optimization actions to reduce power consumption of the underutilized devices.
